(19) United States
(12) Patent Application Publication
(10) Pub. No.: US 2012/0201092 A1
(43) Pub. Date: Aug. 9, 2012

(54) MIXING APPARATUS OF COMBUSTIBLE GAS AND COMBUSTION SUPPORTING GAS

(75) Inventors: Ryo Hatano, Ibaraki-shi (JP); Naoki Shimada, Niihama-shi (JP); Eisaburo Miyata, Ichikawa-shi (JP)

(73) Assignee: SUMITOMO CHEMICAL COMPANY, LIMITED, Chuo-ku, Tokyo (JP)

(21) Appl. No.: 13/498,831

(22) PCT Filed: Sep. 27, 2010
(86) PCT No.: PCT/JP2010/067303

§ 371 Date: Mar. 28, 2012

(30) Foreign Application Priority Data
Sep. 30, 2009 (JP) 2009-226837
Sep. 30, 2009 (JP) 2009-226841

(51) Int. Cl. B01F 3/02; B01F 15/02

(52) U.S. Cl. 366/152.1; 366/150.1

(57) ABSTRACT

A mixing apparatus (10A) comprises a tubular mixing section (1) for mixing a combustible gas and a combustion supporting gas; a combustible gas supply port at one end (1a); a combustible gas transport device (3) for supplying the combustible gas into the tubular mixing section (1) from the combustible gas supply port; a mixed gas outlet port of the combustible gas and the combustion supporting gas at the other end (1b); and a combustion supporting gas supply tube (5) connected to the tubular mixing section (1) between the one end (1a) and the other end (1b) for supplying the combustion supporting gas into the tubular mixing section (1) from a combustion supporting gas supply port (5a). The combustible gas transport device (3) can control a flow velocity of the combustible gas at the combustion supporting gas supply port (5a) not less than a combustion velocity of the mixed gas.

### TECHNICAL FIELD

The present invention relates to a mixing apparatus of a combustible gas and a combustion supporting gas, and other apparatus and processes related thereto.

### BACKGROUND ART

A mixed gas of a combustible gas and a combustion supporting gas is used for various reaction processes. For example, it is known that a mixed gas obtained by mixing hydrocarbon gas, e.g. methane, as the combustible gas with the combustion supporting gas such as oxygen is used for a disproportionation reaction for producing carbon monoxide and hydrogen. It is also known that a mixed gas obtained by mixing the combustible gas including hydrogen with the combustion supporting gas including oxygen is used for an oxidation reaction for producing hydrogen peroxide and further an epoxidation reaction for epoxidizing an olefin with the hydrogen peroxide.

As a mixing apparatus of a combustible gas and a combustion supporting gas, for example, there is known a mixing apparatus having a mixing vessel to which the combustible gas and the combustion supporting gas are supplied, wherein the mixing vessel is filled with packing to form many narrow gas passages and increase a flow velocity of the gas flowing through the mixing vessel (See JP 2009-29680 A).

### SUMMARY OF INVENTION

### Technical Problem

When a combustible gas and a combustion supporting gas are mixed by the conventional mixing apparatus, there is a fear that a combustion reaction may occur during the mixing and there is a concern of propagation of the combustion reaction. In order to attain safer mixing, a mixing apparatus is required which has no fear of propagation of a combustion reaction even if the combustion reaction occurs.

### Solution to Problem

In these circumstances, as a result of diligent consideration by the inventors on a mixing apparatus of a combustible gas (or a flammable gas) and a combustion supporting gas (or a gas supporting burning of the flammable gas), the present invention has been accomplished as follows.

In one aspect of the present invention, there is provided a mixing apparatus for mixing a combustible gas and a combustion supporting gas, which comprises:

a tubular mixing section for mixing the combustible gas and the combustion supporting gas;

a combustible gas supply port located at one end of the tubular mixing section;

a combustible gas transport device for supplying the combustible gas into the tubular mixing section from the combustible gas supply port;

a mixed gas outlet port of a mixed gas of the combustible gas and the combustion supporting gas located at the other end of the tubular mixing section; and

a combustion supporting gas supply tube connected to the tubular mixing section between the one end and the other end of the tubular mixing section for supplying the combustion supporting gas into the tubular mixing section from a combustion supporting gas supply port;

wherein the combustible gas transport device is able to control a flow velocity of the combustible gas at the combustion supporting gas supply port to be not less than a combustion velocity of the mixed gas of the combustible gas and the combustion supporting gas.

In one embodiment of the above mixing apparatus, the tubular mixing section has at least one mixing member selected from the group consisting of a static mixer and a dispersive mixer between the combustion supporting gas supply port and the mixed gas outlet port.

In another embodiment of the above mixing apparatus, the mixing apparatus further comprises a baffle located within the tubular mixing section between the one end of the tubular mixing section and the combustion supporting gas supply port, wherein the combustible gas transport device is able to control a flow velocity of a swirl flow of the combustible gas resulted by the baffle at the combustion supporting gas supply port to be not less than the combustion velocity of the mixed gas of the combustible gas and the combustion supporting gas.

In the latter embodiment, the tubular mixing section may have a tapered part between a position of the combustion supporting gas supply port and a position of the baffle so that a cross-sectional area of the tubular mixing section at the position of the combustion supporting gas supply port is smaller than a cross-sectional area of the tubular mixing section at the position of the baffle.

Also in the latter embodiment, the combustion supporting gas supply tube may be inserted into the tubular mixing section; a tip of the combustion supporting gas supply tube may be bent coaxially with the tubular mixing section; and the baffle may be attached to a periphery of the tip of the combustion supporting gas supply tube.

Alternatively, in the above mixing apparatus, the combustion supporting gas supply tube may be connected to a wall of the tubular mixing section at the combustion supporting gas supply port and may include a porous membrane at the combustion supporting gas supply port.

Regarding the mixing apparatus of the present invention, the combustible gas may comprise hydrogen, and the combustion supporting gas may comprise oxygen. The combustible gas may further comprise propylene, and/or may further comprise an inert component.

In another aspect of the present invention, there is provided a reaction apparatus comprising:

the mixing apparatus described above; and

a reactor connected to the mixed gas outlet port of the mixing apparatus.

In one embodiment of the above reaction apparatus, the reaction apparatus further comprises:

a control valve for controlling a flow rate of the combustion supporting gas flowing through the combustion supporting gas supply tube;

a measuring instrument for measuring a concentration of the combustion supporting gas in the reactor; and

a controller for controlling the flow rate of the combustion supporting gas flowing through the combustion supporting gas supply tube by the control valve based on the concentration of the combustion supporting gas in the reactor which is measured by the measuring instrument.

In this embodiment, the controller is able to control the flow rate of the combustion supporting gas flowing through the combustion supporting gas supply tube by the control valve so as to maintain the concentration of the combustion supporting gas in the reactor at a substantially constant level.

Additionally or alternatively, the reaction apparatus may further comprises a recycle line for returning a gas in the reactor to the combustible gas transport device.

In another aspect of the present invention, there is provided a process for producing a mixed gas, which comprises:

supplying a combustible gas into a tubular mixing section from one end of the tubular mixing section;

supplying a combustion supporting gas into the tubular mixing section from a combustion supporting gas supply port located between the one end and the other end of the tubular mixing section; and

discharging a mixed gas of the combustible gas and the combustion supporting gas from the other end of the tubular mixing section;

wherein the combustible gas supplied from the one end of the tubular mixing section is mixed with the combustion supporting gas supplied from the combustion supporting gas supply port and flows through the tubular mixing section to produce the mixed gas of the combustible gas and the combustion supporting gas from the other end of the tubular mixing section; and a supply flow rate of the combustible gas into the tubular mixing section is controlled so that a flow velocity of the combustible gas at the combustion supporting gas supply port is not less than a combustion velocity of the mixed gas of the combustible gas and the combustion supporting gas.

In one embodiment of the above process for producing the mixed gas, the combustible gas supplied from the one end of the tubular mixing section is made into a swirl flow by a baffle, and then it is mixed with the combustion supporting gas supplied from the combustion supporting gas supply port; and the flow velocity of the combustible gas at the combustion supporting gas supply port is a flow velocity of the swirl flow.

In this embodiment, the combustible gas may flow through the tubular mixing section in which a cross-sectional area of the tubular mixing section at a position of the combustion supporting gas supply port is smaller than a cross-sectional area of the tubular mixing section at a position of the baffle.

Regarding the process for producing the mixed gas of the present invention, the combustible gas may comprise hydrogen, and the combustion supporting gas may comprise oxygen. The combustible gas may further comprise propylene, and/or may further comprise an inert component.

In another aspect of the present invention, there is provided a process for supplying a mixed gas, which comprises:

supplying a reactor with the mixed gas produced by the process for producing the mixed gas described above;

measuring a concentration of the combustion supporting gas in the reactor; and

controlling the supply of the combustion supporting gas into the tubular mixing section.

In one embodiment of the above process for supplying the mixed gas, the supply of the combustion supporting gas into the tubular mixing section is controlled so as to maintain the concentration of the combustion supporting gas in the reactor at a substantially constant level.

In one embodiment of the above process for supplying the mixed gas, the process further comprises:

taking out a gas from the reactor to reuse the gas for the combustible gas which is to be supplied to the tubular mixing section.

### Advantageous Effects of Invention

According to the present invention, there is provided a safer mixing apparatus which can effectively prevent propagation of occurrence of a combustion reaction although a combustible gas and a combustion supporting gas are mixed together.

### BRIEF DESCRIPTION OF DRAWINGS

FIG. 1 schematically shows a cross sectional view of a mixing apparatus in one embodiment of the present invention.

FIG. 2 shows a graph of an equilateral-triangular coordinate of a combustible gas of 5 parts by weight of propylene and 1.7 parts by weight of hydrogen (Propylene+H₂), a combustion supporting gas (Oxygen, O₂), and an inert gas (Nitrogen, N₂).

FIG. 3 schematically shows a cross sectional view of a mixing apparatus in another embodiment of the present invention.

FIG. 4 schematically shows a cross sectional view of an example of a mixing member which can be used for the present invention.

FIG. 5 schematically shows a cross sectional view of another example of a mixing member which can be used for the present invention.

FIG. 6 schematically shows a cross sectional view of a mixing apparatus in another embodiment of the present invention.

FIG. 7 schematically shows a cross sectional view of a mixing apparatus in another embodiment of the present invention.

FIG. 8 schematically shows a cross sectional view of a mixing apparatus in another embodiment of the present invention.

FIG. 9 schematically shows a cross sectional view of a mixing apparatus in another embodiment of the present invention.

FIG. 10 schematically shows a cross sectional view of a mixing apparatus in another embodiment of the present invention.

FIG. 11 schematically shows a front view of a baffle used in the embodiment of FIG. 10 (the view seeing from an upstream side).

FIG. 12 schematically shows a cross sectional view of a mixing apparatus in another embodiment of the present invention.

FIG. 13 schematically shows a cross sectional view of a reaction apparatus in one embodiment of the present invention.

FIG. 14 schematically shows a cross sectional view of a reaction apparatus in another embodiment of the present invention.

FIG. 15 schematically shows a cross sectional view of a tubular mixing section of a mixing apparatus used in Example 1.

FIG. 16 schematically shows a cross sectional view of a tubular mixing section of a mixing apparatus used in Example 2.

FIG. 17 schematically shows a cross sectional view of a tubular mixing section of a mixing apparatus used in Example 3.

Following reference numbers or signs denote the following elements:
1, 1′, 1″, 1′″ . . . tubular mixing section
1a . . . one end (combustible gas supply port)
1b . . . the other end (mixed gas outlet port)
1c . . . tapered part
3 . . . combustible gas transport device
5, 5′, 5″ . . . combustion supporting gas supply tube
5a, 5a′, 5a″ . . . combustion supporting gas supply port
7 . . . mixing member
7a . . . static mixer
7b . . . dispersive mixer
8, 8′ . . . baffle
9 . . . porous membrane
10A to 10H . . . mixing apparatus
11 . . . reaction apparatus
13 . . . control valve
15 . . . (combustion supporting gas concentration) measuring instrument
17 . . . controller
19 . . . recycle line
20, 20′ . . . reaction apparatus
D1, D2, D3 . . . inner diameter
X . . . Propylene+H₂ (combustible component of combustible gas) 100% by volume
Y . . . O₂ (combustion supporting gas) 100% by volume
Z . . . N₂ (inert component of combustible gas) 100% by volume
A . . . stoichiometric composition
B . . . limiting oxygen concentration
Line AB . . . stoichiometric composition line
C . . . lower explosion limit (O₂)
D . . . upper explosion limit (O₂)
Line BC, Line BD . . . explosion limit
E . . . composition of combustible gas to be supplied
Line EY . . . operating line
F, G . . . limiting concentration
H . . . intersection of stoichiometric composition line and operating line

### DESCRIPTION OF EMBODIMENTS

### Embodiment 1

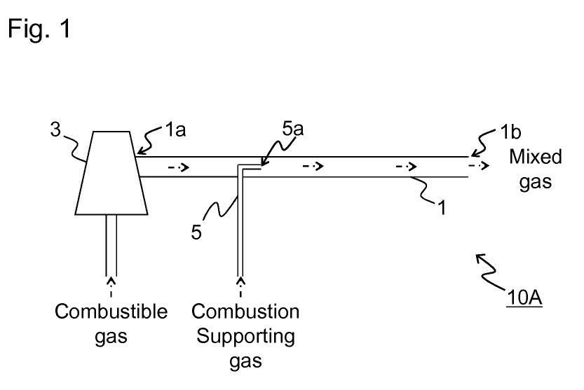

A mixing apparatus and a process for producing a mixed gas in one embodiment of the present invention will be described with reference to FIG. 1.

A mixing apparatus 10A in this embodiment is provided with a tubular mixing section 1; a combustible gas supply port formed at one end 1a of the tubular mixing section 1; a combustible gas transport device 3 for supplying a combustible gas into the tubular mixing section 1 from the combustible gas supply port; a mixed gas outlet port of a mixed gas of the combustible gas and a combustion supporting gas, formed at the other end 1b of the tubular mixing section; and a combustion supporting gas supply tube 5 connected to the tubular mixing section 1 between the one end 1a and the other end 1b of the tubular mixing section 1 for supplying the combustion supporting gas into the tubular mixing section 1 from a combustion supporting gas supply port 5a.

The tubular mixing section 1 is a member for mixing the combustible gas and the combustion supporting gas therein. The tubular mixing section 1 may be of any shape as long as it has the combustible gas supply port and the mixed gas outlet port at the opposing ends 1a and 1b respectively, and has a continuous body between these opposing ends 1a and 1b. The tubular mixing section 1 may have any cross-sectional shape and any cross-sectional area, but the tubular mixing section 1 shown in the drawings as the embodiment has a generally circular cross-section.

The combustible gas transport device 3 is not limited as long as it is able to supply the combustible gas at an appropriate flow velocity as described below. Examples of it may include a centrifugal compressor, an axial flow compressor, a volume compressor, a fan, a blower, and so on.

The combustion supporting gas supply tube 5 has the combustion supporting gas supply port 5a which is communicated with an inside of the tubular mixing section 1. As shown in FIG. 1, for example, the combustion supporting gas supply tube 5 is inserted into the tubular mixing section 1 between the one end 1a and the other end 1b of the tubular mixing section 1, a tip of the combustion supporting gas supply tube 5 is bent, and the combustion supporting gas supply port 5a is open towards a downstream side of the tubular mixing section (right side in FIG. 1). The combustion supporting gas supply tube 5 may have any suitable cross-sectional shape and cross-sectional area, but the combustion supporting gas supply tube 5 shown in the drawings as the embodiment has a generally circular cross-section. The combustion supporting gas supply tube 5 can be equipped with, in general, a control valve (not shown in FIG. 1) for controlling a flow rate of the combustion supporting gas flowing therethrough, but this is not necessary for this embodiment.

Using the mixing apparatus 10A, the combustible gas and the combustion supporting gas are mixed together. The combustible gas is any gas including a component which is able to combust by a reaction with oxygen (hereinafter referred to as a “combustible component”). For example, the combustible component is hydrogen, hydrocarbon compounds including olefins, and a mixture of at least two of them, and the like. In addition to the combustible component, the combustible gas may further include an inert component such as nitrogen, moisture and so on. The combustion supporting gas is any gas including oxygen. For example, the combustion supporting gas is oxygen gas, air, and the like.

With the use of the combustible gas transport device 3, the combustible gas is supplied into the tubular mixing section 1 from the combustible gas supply port located at the one end 1a. Also, the combustion supporting gas is supplied into the tubular mixing section 1 from the combustion supporting gas supply port 5a through the combustion supporting gas supply tube 5. The combustible gas, which is supplied by the combustible gas transport device 3 as described, then passes by the combustion supporting gas supply port 5a of the combustion supporting gas supply tube 5, and flows within the tubular mixing section 1 together with the combustion supporting gas, which is supplied from the combustion supporting gas supply port 5a. Finally, a mixed gas of the combustible gas and the combustion supporting gas is obtained from the mixed gas outlet port located at the other end 1b of the tubular mixing section 1.

During this operation, the combustible gas transport device 3 is used to control (or adjust) the supply flow rate of the combustible gas into the tubular mixing section so that a flow velocity of the combustible gas at the combustion supporting gas supply port 5a is not less than a combustion velocity of the mixed gas of the combustible gas and the combustion supporting gas.

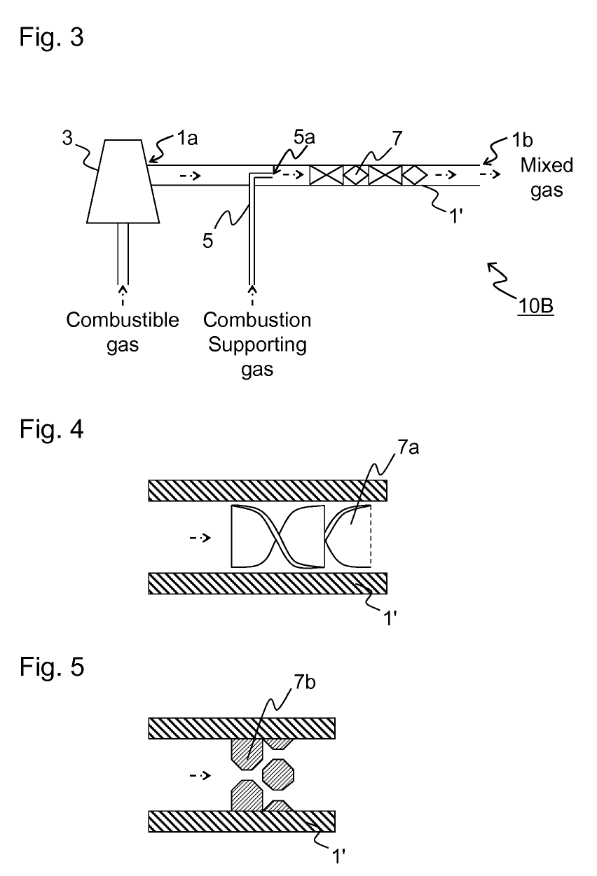

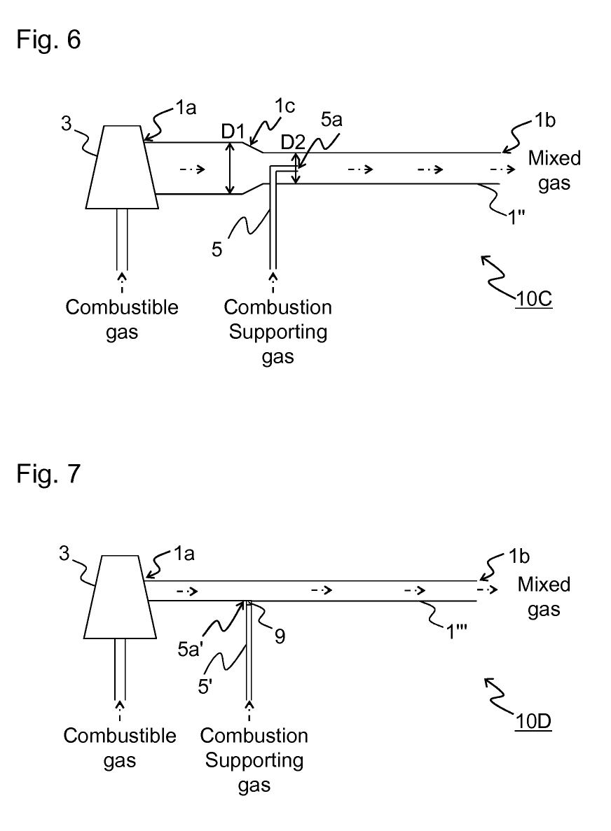

In a case where the mixing apparatus has the tubular mixing section of a generally cylindrical shape as shown in FIGS. 1 and 3 or a tubular mixing section having a tapered part 1c as shown in FIG. 6 (FIGS. 3 and 6 will be described later), the flow velocity of the combustible gas at the combustion supporting gas supply port 5a is substantially equal to or larger than a flow velocity of the combustible gas at the combustible gas supply port of the tubular mixing section.

By controlling as described above, even if a combustion reaction occurs, the combustible gas flows at the flow velocity not less than the combustion velocity, and therefore it is possible to effectively prevent the combustion reaction from being propagated.

Due to the “flow velocity of the combustible gas at the combustion supporting gas supply port” being not less than the combustion velocity of the mixed gas of the combustible gas and the combustion supporting gas, occurrence and propagation of the combustion reaction tends to be suppressed even in the vicinity of the combustion supporting gas supply port 5a where a concentration of the combustion supporting gas is considered to be relatively high. The smaller concentration of the combustion supporting gas is more preferred since ignition tends to be more difficult. The flow velocity of the combustible gas at the combustion supporting gas supply port 5a can be calculated based on the size and shape of the used tubular mixing section 1, the position of the combustion supporting gas supply port 5a in the tubular mixing section 1 and so on, and can be controlled by changing the supply rate (or amount) of the combustible gas from the combustible gas transport device 3.

The combustion velocity of the mixed gas of the combustible gas and the combustion supporting gas is calculated based on a composition of the mixed gas. The combustion velocity of the mixed gas having a certain composition is measurable according to a known spherical bomb technique which is described in “The Burning Velocity Measurement by Means of the Spherical Bomb Technique”, Tadao TKENO and Toshio IIJIMA, Bulletin of the Institute of Space and Aeronautical Science, University of Tokyo, 17(1_B), pp 261-272, 1980. Generally, a mixed gas prepared to have a certain composition is charged into a spherical bomb and ignited; a change in a pressure over time is measured; a combustion (or burning) velocity is calculated from results of the measurement.

The composition of the mixed gas of the combustible gas and the combustion supporting gas at the mixed gas outlet port located at the other end 1b of the tubular mixing section 1 is considered as being equal to a composition resulted by combining the combustible gas and the combustion supporting gas which are supplied. The composition of the gas in the tubular mixing section 1 at an upstream side (left side in FIG. 1) from the combustion supporting gas supply port 5a is generally equal to the composition of the combustible gas which is supplied. The composition of the gas at a downstream side from the combustion supporting gas supply port 5a may be varied depending on flow conditions (or mixing conditions) from the point of view of microscopic scale.

When the combustible gas does not include an inert component, as the “combustion velocity of the mixed gas of the combustible gas and the combustion supporting gas”, a combustion velocity having a “stoichiometric” composition can be applied. The “stoichiometric composition” means herein a composition with respect to two components of the combustible component in the combustible gas and oxygen in the combustion supporting gas, in which oxygen exists at a theoretical amount necessary for combusting the combustible component. As the combustion supporting gas is mixed with the combustible gas gradually, the gas composition during the mixing moves from one corresponding to the composition of the combustible component of the supplied combustible gas, towards another corresponding to the oxygen content in the supplied combustion supporting gas. Then, it is contemplated that the maximum combustion velocity is attained when the gas composition reaches the stoichiometric composition because the oxygen content is just in proportion which is necessary for combusting the combustible component. Therefore, when the “flow velocity of the combustible gas at the combustion supporting gas supply port” is not less than a combustion velocity at the stoichiometric composition, propagation of the combustion reaction is supposed to be prevented sufficiently.

When the combustible gas includes an inert component, a combustion velocity having a certain composition can be applied. In a graph of an equilateral-triangular coordinate of three components (vol %) of a combustible component of the combustible gas, oxygen of the combustion supporting gas, and the inert component of the combustible gas, the certain composition is at an intersection of a stoichiometric composition line, on which the combustible component and oxygen forms a stoichiometric composition, and an “operating line”. The “operating line” means herein a line between a point indicating the composition of the combustible component and the inert component in the supplied combustible gas and a point indicating the oxygen content in the supplied combustion supporting gas. As the combustion supporting gas is mixed with the combustible gas gradually, the gas composition moves from the point indicating the composition of the combustible component and the inert component in the supplied combustible gas, towards the point indicating the oxygen content in the supplied combustion supporting gas, while tracing the operating line. Then, it is contemplated that the maximum combustion velocity is attained when the gas composition reaches the stoichiometric composition. Therefore, when the “flow velocity of the combustible gas at the combustion supporting gas supply port” is not less than a combustion velocity at this stoichiometric composition, propagation of the combustion reaction is supposed to be prevented sufficiently.

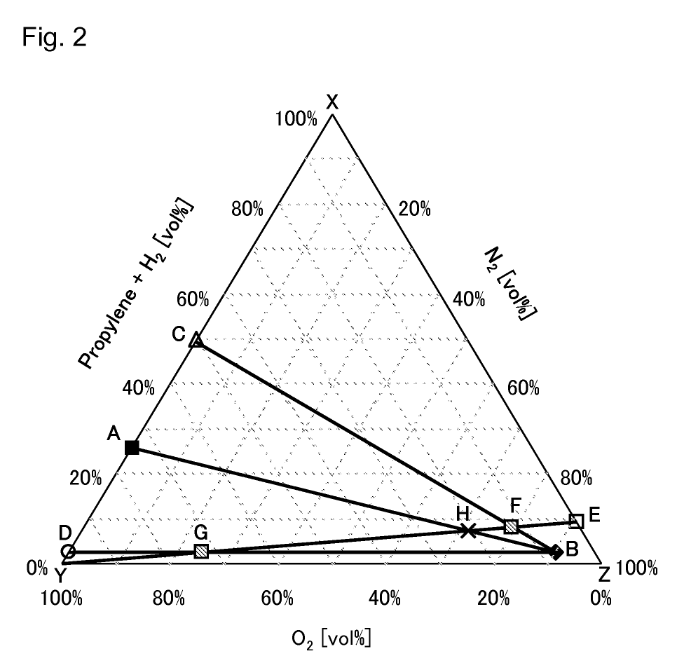

Hereinafter, the composition of the mixed gas for determining the “combustion velocity of the mixed gas of the combustible gas and the combustion supporting gas” is described more concretely with reference to FIG. 2.

FIG. 2 shows a graph of an equilateral-triangular coordinate of a combustible gas of 5 parts by weight of propylene and 1.7 parts by weight of hydrogen (Propylene+H₂), a combustion supporting gas (Oxygen, O₂), and an inert gas (Nitrogen, N₂). At a point X, Propylene+H₂=100% by volume; at a point Y, O₂=100% by volume; and at a point Z, N₂=100% by volume.

When a mixed gas of 5 parts by weight of propylene and 1.7 parts by weight of hydrogen is used as a combustible component of the combustible gas, a stoichiometric composition of the combustible component and oxygen (no nitrogen) is at a point A (Propylene+H₂=22.2% by volume; O₂=77.8% by volume) in FIG. 2. By adding nitrogen as an inert component to such a mixed gas gradually, the composition moves from the point A towards a point Z tracing a line AZ while maintaining the stoichiometric composition of the combustible component and oxygen. As a ratio of nitrogen comes to be high enough, explosion will not occur. A concentration of oxygen at this limit is referred to as a limiting oxygen concentration and indicated by a point B (Propylene+H₂=2.3% by volume; O₂=8.0% by volume) in FIG. 2. A line AB is a stoichiometric composition line. On the other hand, under the condition of no nitrogen, explosion will not occur when the concentration of oxygen is too low or too high. Concentrations of oxygen at these limits are referred to as a lower explosion limit (O₂) and an upper explosion limit (O₂), and indicated by a point C (Propylene+H₂=49.5% by volume; O₂=50.5% by volume) and a point D (Propylene+H₂=2.3% by volume; O₂=97.7% by volume), respectively. A line BC and a line BD are borders of explosion, and a region enclosed by the points B, C and D is a range of explosion.

When the combustible gas is composed of the combustible component in the form of the mixed gas of 5 parts by weight of propylene and 1.7 parts by weight of hydrogen and does not include an inert component, the stoichiometric composition of the combustible component and oxygen is at the point A in FIG. 2. An oxygen gas (O₂=100% by volume) is used as the combustion supporting gas and mixed with the above combustible gas gradually, the gas composition during the mixing moves from a point X towards a point Y tracing a line XY (N₂=0% by volume). It is contemplated that the maximum combustion velocity is attained when the gas composition reaches the stoichiometric composition of the point A. Therefore, the combustion velocity of the mixed gas having the composition of the point A is applied as the “combustion velocity of the mixed gas of the combustible gas and the combustion supporting gas.”

When the combustible gas is composed of the combustible component in the form of the mixed gas of 5 parts by weight of propylene and 1.7 parts by weight of hydrogen and an inert component of a nitrogen gas, a composition of the supplied combustible gas is assumed to be at a point E (Propylene+H₂=6.9% by volume; O₂=1.7% by volume; N₂=91.4% by volume), for descriptive purpose. An oxygen gas (O₂=100% by volume) is used as the combustion supporting gas and mixed with the above combustible gas gradually, the gas composition during the mixing moves from the point E towards the point Y tracing a line EY. It is contemplated that the maximum combustion velocity is attained when the gas composition reaches the stoichiometric composition of a point H. The point H is an intersection of the line EY as an operating line and the line AB as the stoichiometric composition line. Points F and G are intersections of the line EY as the operating line and the lines BC and BD respectively, and the points F and G mean limiting concentrations (upper and lower limits of a fuel concentration when a gas having the composition of the point E is mixed with a gas having the composition of the point Y (O₂=100% by volume)). Therefore, the combustion velocity of the mixed gas having the composition of the point H is applied as the “combustion velocity of the mixed gas of the combustible gas and the combustion supporting gas”.

When other components are used for the combustible gas and the combustion supporting gas, the “combustion velocity of the mixed gas of the combustible gas and the combustion supporting gas” will also be determined with reference to the above explanations, and it will be possible to control the mixing conditions by using the combustible gas transport device so that the “flow velocity of the combustible gas at the combustion supporting gas supply port” is not less than the “combustion velocity of the mixed gas of the combustible gas and the combustion supporting gas.”

As a result, even if the combustion reaction occurs, since the combustible gas flows at a flow velocity which is not less than the combustion velocity, the combustible gas blows out the combustion reaction and therefore propagation of the combustion reaction can be effectively prevented. Since this effect of preventing the propagation of the combustion reaction is significant, it becomes possible to reduce a content ratio of an inert gas in the combustible gas and/or the combustion supporting gas, and therefore to improve a production efficiency of the mixed gas per volume (or space). Further, packing becomes unnecessary or its amount can be reduced, thus it becomes possible to improve a production efficiency of the mixed gas per volume and to reduce a pressure loss from a supply pressure of the combustible gas and/or the combustion supporting gas during the production of the mixed gas. Furthermore, due to the low pressure loss, a cost for driving the combustible gas transport device tends to be reduced.

### Embodiment 2

A mixing apparatus and a process for producing a mixed gas in another embodiment of the present invention will be described with reference to FIG. 3. This embodiment is a modification of Embodiment 1 described above, and similar explanations to Embodiment 1 are applicable to this embodiment unless otherwise stated.

As to a mixing apparatus 10B in this embodiment, a tubular mixing section 1′ is provided therein with a mixing member 7 between the combustion supporting gas supply port 5a and the other end 1b of the tubular mixing section. Since the mixing member 7 is inserted between the combustion supporting gas supply port 5a and the other end 1b of the tubular mixing section, the combustible gas and the combustion supporting gas can be mixed together more rapidly, and propagation of the combustion reaction can be prevented more effectively.

As the mixing member 7, for example, a static mixer (swirling mechanism), a dispersive mixer or the like can be used (FIG. 3 shows a static mixer for illustrative purpose).

The static mixer, for example, may have a structure such as a static mixer 7a shown in FIG. 4 (FIG. 4 shows an enlarged view of a part inside the tubular mixing section 1′; the static mixer 7a may have any suitable length and/or number of elements) to swirl the combustible gas and the combustion supporting gas together. As the static mixer, for example, those available from Noritake Co., Limited, (Japan) can be used. When the static mixer is used, it is advantageous in that a pressure loss is relatively small. Further, a mixing effect is attained homogeneously in a radial direction within the tubular mixing section 1.

The dispersive mixer, for example, may have a structure such as a dispersive mixer 7b shown in FIG. 5 (FIG. 5 shows an enlarged view of a part inside the tubular mixing section 1′; the dispersive mixer 7b is, for example, formed to have hourglass-shaped holes in a staggered array and may have any suitable length and/or number of elements) to distribute (or divide) and mix the combustible gas and the combustion supporting gas together. As the dispersive mixer, for example, “Bunsankun” available from Fujikin Incorporated (Japan) can be used. When the dispersive mixer is used, since it gives a relatively large contact area of the dispersive mixer with the gas, the dispersive mixer made of a material having a high thermal conductivity such as a metal can exert a nonexplosion effect by cooling a flame. Mixing zones in the dispersive mixer are preferably independent from each other.

### Embodiment 3

A mixing apparatus and a process for producing a mixed gas in another embodiment of the present invention will be described with reference to FIG. 6. This embodiment is a modification of Embodiment 1 described above, and similar explanations to Embodiment 1 are applicable to this embodiment unless otherwise stated.

As to a mixing apparatus 10C in this embodiment, a tapered part 1c is formed between a position where the combustion supporting gas supply port 5a exists and a position in the vicinity of the one end 1a of a tubular mixing section 1″ so that a cross-sectional area of the tubular mixing section 1″ at the position of the combustion supporting gas supply port 5a is smaller than a cross-sectional area of the tubular mixing section 1″ at the position in the vicinity of the one end 1a of the tubular mixing section.

In a case where the tubular mixing section has a generally circular cross-section, an inner diameter D1 of the tubular mixing section 1″ at the position in the vicinity of the one end 1a of the tubular mixing section is larger than an inner diameter D2 of the tubular mixing section 1″ at the position of the combustion supporting gas supply port 5a. As shown in FIG. 6, a generally cylindrical part located at an upstream side (one end 1a side) of the tapered part 1c and a generally cylindrical part located at a downstream side (the other end 1b side) of the tapered part 1c can be substantially coaxially arranged, and the tapered part 1c has a shape of a circular truncated cone to form a continuous connection between these generally cylindrical parts.

The inner diameter D2 of the tubular mixing section 1″ at the position of the combustion supporting gas supply port 5a is shown in the drawings as being equal to an inner diameter of the generally cylindrical part located at the downstream side of the tapered part 1c, but the present embodiment is not limited thereto.

According to the present embodiment, the combustible gas is to flow through a smaller cross-sectional area at the position of the combustion supporting gas supply port 5a, thereby the flow velocity of the combustible gas is further increased. To this extent, a load for the combustible gas transport device can be further reduced while the flow velocity of the combustible gas at the combustion supporting gas supply port 5a is effectively controlled to be not less than the combustion velocity of the mixed gas of the combustible gas and the combustion supporting gas. Alternatively, when the operation conditions of the combustible gas transport device are maintained, since the flow velocity of the combustible gas is increased, propagation of the combustion reaction can be prevented more securely.

### Embodiment 4

A mixing apparatus and a process for producing a mixed gas in another embodiment of the present invention will be described with reference to FIG. 7. This embodiment is a modification of Embodiment 1 described above, and similar explanations to Embodiment 1 are applicable to this embodiment unless otherwise stated.

As to a mixing apparatus 10D in this embodiment, a combustion supporting gas supply tube 5′ is connected to a wall of a tubular mixing section 1′″ at a combustion supporting gas supply port 5a′, for example, in the form of a T-junction as shown in the drawings.

Preferably, it is provided with a porous membrane 9 at the combustion supporting gas supply port 5a′. The porous membrane 9 can be any membrane which has a gas permeability. For example, ceramics, metal meshes, polymer membranes, sintered metal membranes can be used. The existence of the porous membrane 9 can prevent occurrence of combustion within the combustion supporting gas supply tube 5′.

According to the present embodiment, the combustion supporting gas is supplied into the tubular mixing section 1′″ from the combustion supporting gas supply port 5a′ connected to the wall of the tubular mixing section 1′″, preferably through the porous membrane 9, thereby the combustion supporting gas can be supplied while being dispersed, and thus can be mixed with the combustible gas rapidly.

### Embodiment 5

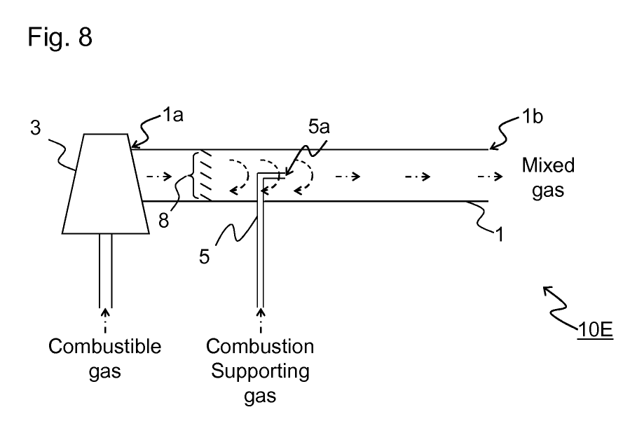

A mixing apparatus and a process for producing a mixed gas in another embodiment of the present invention will be described with reference to FIG. 8. This embodiment is a modification of Embodiment 1 described above, and similar explanations to Embodiment 1 are applicable to this embodiment unless otherwise stated.

A mixing apparatus 10E in this embodiment is provided with a tubular mixing section 1; a combustible gas supply port formed at one end 1a of the tubular mixing section 1; a combustible gas transport device 3 for supplying a combustible gas into the tubular mixing section 1 from the combustible gas supply port; a mixed gas outlet port of a mixed gas of the combustible gas and a combustion supporting gas, formed at the other end 1b of the tubular mixing section; a combustion supporting gas supply tube 5 connected to the tubular mixing section 1 between the one end 1a and the other end 1b of the tubular mixing section 1 for supplying the combustion supporting gas into the tubular mixing section 1 from a combustion supporting gas supply port 5a; and a baffle 8 located within the tubular mixing section 1 between the one end 1a of the tubular mixing section 1 and the combustion supporting gas supply port 5a.

The baffle 8 can be any baffle which is able to make the flow of the combustible gas supplied from the one end 1a of the tubular mixing section 1 into a swirl flow (which is schematically shown by an arrowed and dotted semicircle lines in the drawings). For example, the baffle 8 may be a plurality of plate-like members which are angularly tilted with respect to the axis of the tubular mixing section 1, and which may be or may not be symmetrically arranged with respect to the axis of the tubular mixing section 1. More specifically, for example, eight fins are located at every 45 degrees. Further, a reducer may be used to improve a swirl velocity of the gas.

In the present embodiment, the combustible gas supplied by the combustible gas transport device 3 is made into a swirl flow by the baffle 8, and then it passes by the combustion supporting gas supply port 5a of the combustion supporting gas supply tube 5, and flows within the tubular mixing section 1 together with the combustion supporting gas, which is supplied from the combustion supporting gas supply port 5a. Finally, a mixed gas of the combustible gas and the combustion supporting gas is obtained from the mixed gas outlet port located at the other end 1b of the tubular mixing section 1.

During this operation, the combustible gas transport device 3 is used to control (or adjust) the supply flow rate of the combustible gas into the tubular mixing section 1 so that a flow velocity of the swirl flow of the combustible gas at the combustion supporting gas supply port 5a is not less than a combustion velocity of the mixed gas of the combustible gas and the combustion supporting gas.

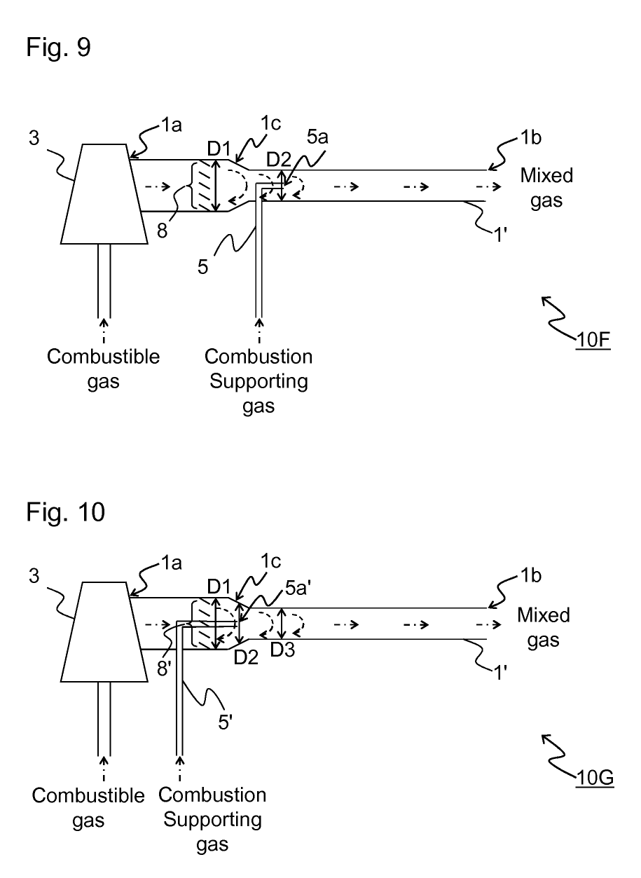

In a case where the mixing apparatus has the tubular mixing section of a generally cylindrical shape as shown in FIG. 8 or a tubular mixing section having a tapered part 1c as shown in FIGS. 9 and 10 (FIGS. 9 and 10 will be described later), the flow velocity of the combustible gas at the combustion supporting gas supply port 5a is substantially equal to or larger than a flow velocity of the combustible gas at the combustible gas supply port of the tubular mixing section.

By controlling as described above, even if a combustion reaction occurs, the combustible gas flows at the flow velocity not less than the combustion velocity, and therefore it is possible to prevent the combustion reaction from being propagated.

In this embodiment, the “flow velocity of the combustible gas at the combustion supporting gas supply port” described above in Embodiment 1 is replaced with the “flow velocity of the swirl flow of the combustible gas at the combustion supporting gas supply port”. The flow velocity of the swirl flow of the combustible gas at the combustion supporting gas supply port 5a can be calculated based on the size and shape of the used tubular mixing section 1, the shape of the baffle 8, the position of the combustion supporting gas supply port 5a in the tubular mixing section 1 and so on, and can be controlled by changing the supply rate (or amount) of the combustible gas from the combustible gas transport device 3.

According to the present embodiment, the combustible gas is made into the swirl flow by the baffle 8 before arriving at the combustion supporting gas supply port 5a, thereby the flow velocity of the combustible gas can be increased more than that in a case where the combustible gas flows naturally. To this extent, a load for the combustible gas transport device can be reduced while the flow velocity of the swirl flow of the combustible gas at the combustion supporting gas supply port 5a is effectively controlled to be not less than the combustion velocity of the mixed gas of the combustible gas and the combustion supporting gas.

On the other hand, the conventional mixing apparatus is filled with packing, and therefore it has a problem of a large pressure loss. Thus, there has been a need for a mixing apparatus which is able to mix a combustible gas and a combustion supporting gas and attain a smaller pressure loss. According to the present embodiment, there is provided a mixing apparatus which is able to mix a combustible gas and a combustion supporting gas and attain a smaller pressure loss. The mixing apparatus of the present embodiment show a smaller pressure loss than that of the conventional mixing apparatus filled with packing, and is very effective.

### Embodiment 6

A mixing apparatus and a process for producing a mixed gas in another embodiment of the present invention will be described with reference to FIG. 9. This embodiment is a modification of Embodiment 5 described above, and similar explanations to Embodiment 5 are applicable to this embodiment unless otherwise stated.

As to a mixing apparatus 10F in this embodiment, a tapered part 1c is formed between a position where the combustion supporting gas supply port 5a exists and a position where the baffle 8 is located so that a cross-sectional area of a tubular mixing section 1′ at the position of the combustion supporting gas supply port 5a is smaller than a cross-sectional area of the tubular mixing section 1′ at the position of the baffle 8.

In a case where the tubular mixing section has a generally circular cross-section, an inner diameter D1 of the tubular mixing section 1′ at the position of the baffle 8 is larger than an inner diameter D2 of the tubular mixing section 1′ at the position of the combustion supporting gas supply port 5a. As shown in FIG. 9, a generally cylindrical part located at an upstream side (one end 1a side) of the tapered part 1c and a generally cylindrical part located at a downstream side (the other end 1b side) of the tapered part 1c can be substantially coaxially arranged, and the tapered part 1c has a shape of a circular truncated cone to form a continuous connection between these generally cylindrical parts.

The inner diameter D2 of the tubular mixing section 1′ at the position of the combustion supporting gas supply port 5a is shown in the drawings as being equal to an inner diameter of the generally cylindrical part located at the downstream side of the tapered part 1c, but the present embodiment is not limited thereto.

According to the present embodiment, after the combustible gas is made into the swirl flow by the baffle 8, it is to flow through a smaller cross-sectional area at the position of the combustion supporting gas supply port 5a, thereby the flow velocity of the swirl flow of the combustible gas is further increased. To this extent, a load for the combustible gas transport device can be further reduced while the flow velocity of the swirl flow of the combustible gas at the combustion supporting gas supply port 5a is effectively controlled to be not less than the combustion velocity of the mixed gas of the combustible gas and the combustion supporting gas. Alternatively, when the operation conditions of the combustible gas transport device are maintained, since the flow velocity of the swirl flow of the combustible gas is increased, propagation of the combustion reaction can be prevented more securely.

### Embodiment 7

A mixing apparatus and a process for producing a mixed gas in another embodiment of the present invention will be described with reference to FIG. 10. This embodiment is a modification of Embodiment 6 described above, and similar explanations to Embodiment 6 are applicable to this embodiment unless otherwise stated.

As to a mixing apparatus 10G in this embodiment, a combustion supporting gas supply tube 5′ is inserted into the tubular mixing section 1′ and a tip thereof is bent coaxially with the tubular mixing section, similarly to Embodiment 6. However, differently from Embodiment 6, its insertion position is located at an upstream side (one end 1a side) of a baffle 8′, and the baffle 8′ is attached to a periphery of the tip of the combustion supporting gas supply tube 5′.

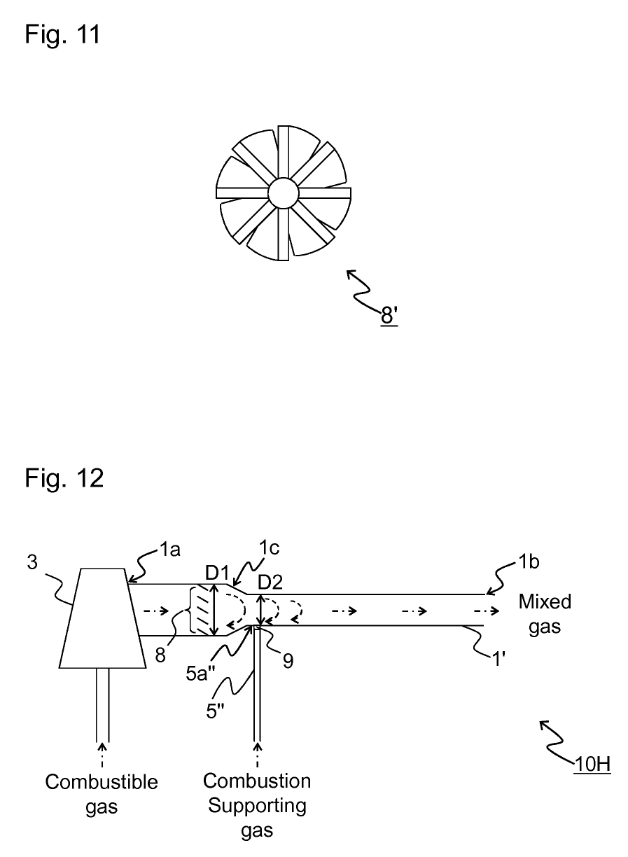

As the baffle 8′, for example, a baffle having a plurality of wings which are fixed thereto coaxially and angularly tilted as shown in FIG. 11 can be used.

In the embodiment shown in FIG. 10, the combustion supporting gas supply port 5a′ of the combustion supporting gas supply tube 5′ is located within the tapered part 1c, and the inner diameter D2 of the tubular mixing section 1′ at the position of the combustion supporting gas supply port 5a′ is larger than the inner diameter D3 of the generally cylindrical part located at a downstream side of the tapered part 1c. However, the present embodiment is not limited thereto, the combustion supporting gas supply port 5a may be located at a downstream side (the other end 1b side) of the tapered part 1c, and these inner diameters D2 and D3 can be equal to each other, similarly to Embodiment 6.

According to the present embodiment, the baffle 8′ can be attached to the periphery of the combustion supporting gas supply tube 5′, thereby the apparatus can be assembled readily.

### Embodiment 8

A mixing apparatus and a process for producing a mixed gas in another embodiment of the present invention will be described with reference to FIG. 12. This embodiment is a modification of Embodiment 6 described above, and similar explanations to Embodiment 6 are applicable to this embodiment unless otherwise stated.

As to a mixing apparatus 10H in this embodiment, a combustion supporting gas supply tube 5″ is connected to a wall of a tubular mixing section 1′ at a combustion supporting gas supply port 5a″, for example, in the form of a T-junction as shown in the drawings.

It is provided with a porous membrane 9 at the combustion supporting gas supply port 5a″. The porous membrane 9 can be any membrane which has a gas permeability. For example, ceramics, metal meshes, polymer membranes, sintered metal membranes can be used. The existence of the porous membrane 9 can prevent occurrence of combustion within the combustion gas supply tube 5″.

According to the present embodiment, the combustion supporting gas is supplied into the tubular mixing section 1′ from the combustion supporting gas supply port 5a″ connected to the wall of the tubular mixing section 1′, through the porous membrane 9, thereby the combustion supporting gas can be supplied while being dispersed, and thus can be mixed with the swirl flow of the combustible gas rapidly.

### Embodiment 9

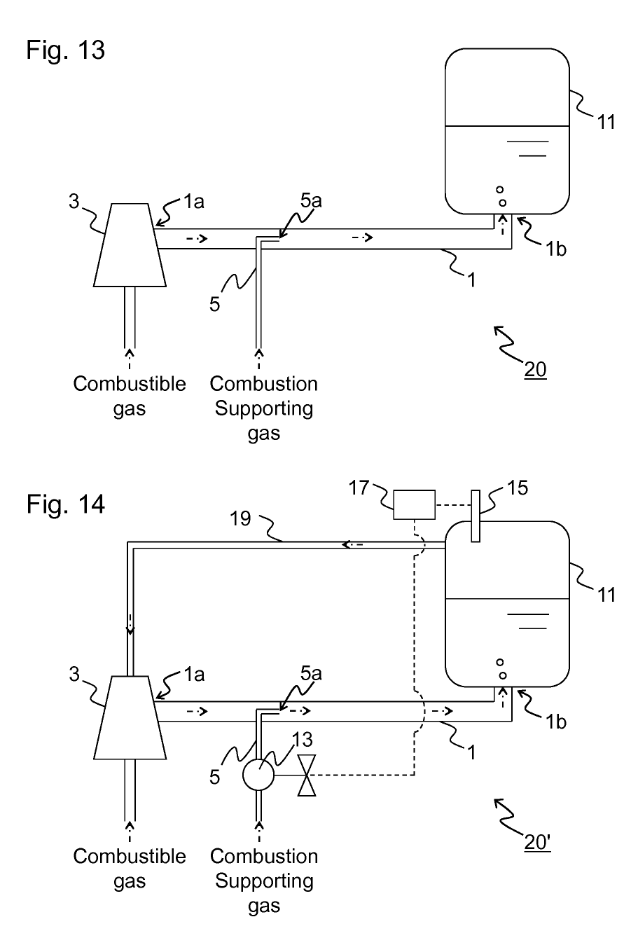

A reaction apparatus and a process for supplying a mixed gas in one embodiment of the present invention will be described with reference to FIG. 13. Similar explanations to any of Embodiments 1 to 8 described above are applicable to this embodiment unless otherwise stated.

A reaction apparatus 20 in this embodiment is provided with the mixing apparatus as described in the above Embodiments 1 to 8, and also a reactor 11 connected to the mixed gas outlet port of the mixing apparatus (in the drawings, the mixing apparatus of the Embodiment 1 is shown for illustrative purpose, and similar members to those in Embodiment 1 are labeled with the same reference numbers). The reactor 11 can be selected depending on a reaction which is intended.

Using the reaction apparatus 20, the combustible gas and the combustion supporting gas are mixed together, and thus obtained mixed gas of the combustible gas and the combustion supporting gas is subjected to a reaction. The mixing is similar to that in any of Embodiments 1 to 8, and the mixed gas of the combustible gas and the combustion supporting gas is obtained from the other end 1b of the tubular mixing section 1. The obtained mixed gas is supplied to the reactor 11 as it is to be subjected to the reaction in the reactor 11 (in FIG. 13, a liquid phase reaction is shown for illustrative purpose).

According to the present embodiment, similar effects to those in Embodiments 1 to 8 can be obtained, and further the combustible gas and the combustion supporting gas can be mixed together safely just prior to supply to the reactor.

Although the present embodiment is not limited, an olefin(s) and hydrogen may be used for the combustible gas, and oxygen may be used for the combustion supporting gas. Hydrogen and oxygen can produce hydrogen peroxide in the reactor 11 and cause an epoxidation reaction of the olefin. For example, when propylene is used as the olefin, it is possible to produce propylene oxide.

### Embodiment 10

A reaction apparatus and a process for supplying a mixed gas in another embodiment of the present invention will be described with reference to FIG. 14. This embodiment is a modification of Embodiment 9 described above, and similar explanations to Embodiment 9 are applicable to this embodiment unless otherwise stated.

A reaction apparatus 20′ in this embodiment is provided with, in addition to the configuration of the apparatus in Embodiment 9 described above, a control valve 13 for controlling a flow rate of the combustion supporting gas flowing through the combustion supporting gas supply tube 5, a measuring instrument 15 for measuring a concentration of the combustion supporting gas in the reactor 11, and a controller 17 which is electrically connected to the measuring instrument 15 and the control valve 13. The reaction apparatus is also provided with a recycle line 19 between the reactor 11 and the combustible gas transport device 3, although this is not necessary to the present embodiment.

The measuring instrument 15 is able to measure a concentration of the combustion supporting gas in the reactor 11, and the controller 17 receives a data signal of the measured concentration and outputs a control signal to the control valve 13 for controlling the flow rate of the combustion supporting gas which flows through the combustion supporting gas supply tube 5. In this way, the flow rate of the combustion supporting gas flowing through the combustion supporting gas supply tube 5 can be controlled via the control valve 13 based on the concentration of the combustion supporting gas in the reactor 11 which is measured by the measuring instrument 15. Thus, it is possible to control the amount of the combustion supporting gas to be supplied to the tubular mixing section 1, and therefore the amount of the combustion supporting gas transferred into the reactor 11, as desired by feedback regulation. The control is conducted, for example, so as to maintain the concentration of the combustion supporting gas in the reactor 11 at a substantially constant level, and thereby the control can be attained to avoid the combustion reaction from being caused in the reactor 11.

A gas in the reactor 11 is mainly composed of the combustible gas as its major part, and thus includes the combustible component which is not consumed by the reaction and optionally an inert component and so on. The gas in the reactor 11 is taken out and returned to the combustible gas transport device 3 through the recycle line 19. Thereby the combustible gas, more specifically the combustible component and optionally the inert component can be reused effectively. However, such configuration is not necessary to the present embodiment.

In the above, some embodiments of the present invention are described, but these embodiments can be modified variously. For example, similarly to Embodiments 6, Embodiment 5 can be modified in the ways as explained in Embodiments 7 and 8. Embodiment 9 may be provided with a recycle line for returning the gas in the reactor to the combustible gas transport device as described in Embodiment 10. The mixed gas prepared according to Embodiments 1 to 8 can be also used for any applications, not only for the reaction apparatus as in Embodiments 9 and 10.

### EXAMPLES

### Example 1

According to Embodiment 2, a combustible gas and a combustion supporting gas were mixed together under various conditions.

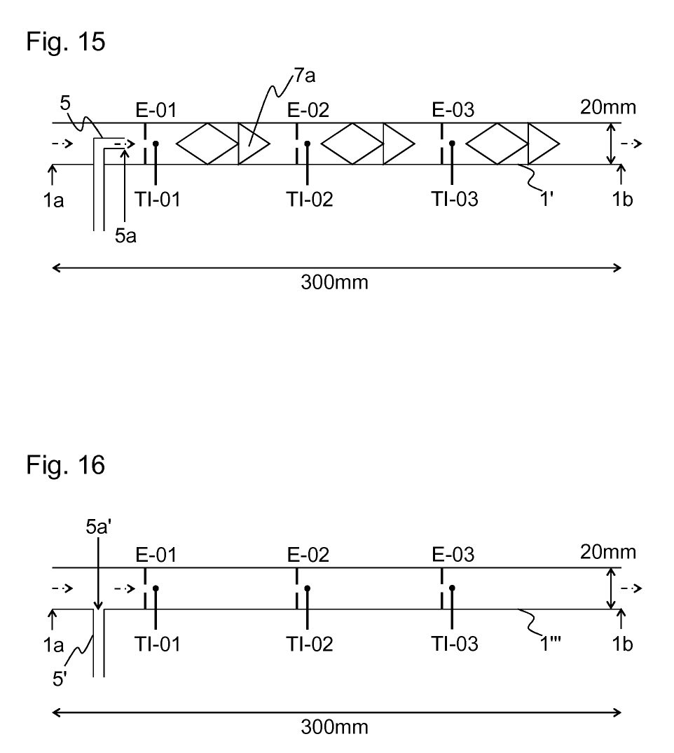

FIG. 15 schematically shows a cross-sectional view of a tubular mixing section of a mixing apparatus which was used. As the tubular mixing section 1′, a straight tube made of SUS (stainless steel) and having an inner diameter of 20 mm and a length of 300 mm was used. As the combustion supporting gas supply tube 5, a round tube made of SUS and having an inner diameter of 5 mm was used while its tip was bent generally coaxially with the tubular mixing section 1′, and an aperture plane of the combustion supporting gas supply port 5a was located at about 50 mm downstream from the one end 1a (the combustible gas supply port) of the tubular mixing section. As the mixing member 7, static mixers 7a which were commercially available (TAH Industries Inc., (via a trading company, Mercury Supply Systems Corporation, Japan) made of SUS, Model No. 090-612) was used. In addition, igniters E-01 to E-03 and temperature sensors TI-01 to TI-03 were set at each of positions in the downstream-side vicinity of the combustion supporting gas supply port 5a, between the combustion supplying gas supply port 5a and the other end 1b (the mixed gas outlet port), in the upstream-side vicinity of the other end 1b, as shown in the drawings. More specifically, from the one end 1a as a point of origin in the downstream direction, E-01 was located at a distance of 55 mm, E-02 was located at a distance of 135 mm, E-03 was located at a distance of 215 mm. The respective thermometers (TI-01 to TI-03) were set at a distance of 10 mm from the respective igniters (E-01 to E-03) in the downstream direction. The static mixers had a length of 45.5 mm, and were set at each of three positions between E-01 and E-02, between E-02 and E-03, between E-03 and 1b while kept away by a distance of 21 mm from the respective upstream-side igniters. The igniter showed a temperature rise of about 10 to 20° C. by spark (measured in a flow at 15 m/s of a nitrogen gas only so as to involve no combustion reaction).

A gas used as the combustible gas was composed of 10% by volume of a mixed gas of 6 parts by weight of propylene and 4 parts by weight of hydrogen, and 90% by volume of a nitrogen gas. A gas used as the combustion supporting gas was 100% by volume of an oxygen gas. The combustion velocity of the mixed gas of the combustible gas and the combustion supporting gas was the combustion velocity of the mixed gas having the composition at the point H in FIG. 2; and as a guide, about 30 m/s was noted in view of a stability limit of flame for propane, which has a similar molecular structure to propylene used in this example.

While the combustible gas and the combustion supporting gas were supplied at respective supply rates of conditions No. 01 to No. 08 shown in Table 1, for each of cases of conducting an ignition operation at E-01, conducting an ignition operation at E-02, and conducting an ignition operation at E-03, the maximum temperatures were measured at TI-01 to TI-03, and whether the operation brought about actual ignition (firing) at any of TI-01 to TI-03 or not was judged. Results are shown in Tables 2 to 9. In the tables, the temperature was indicated by the maximum rise in temperature, and the judgment was shown by the following symbols.

N: not ignited (no firing)

Y−: ignited with a temperature rise less than 100° C.

Y+: ignited with a temperature rise of 100° C. or more

TABLE 1

| | | | | Flow velocity of | |
|---|---|---|---|---|---|
| | | Supply rate of | Oxygen | Combustible gas | Flow velocity |
| | Supply rate of | Combustion | concentration | at Combustion | of mixed gas |
| | Combustible | supporting | at Outlet | supporting gas | at Outlet |
| Condition | gas (m/s) | gas (m/s) | (vol %) | supply port (m/s) | (m/s) |
| No. 01 | 30.0 | 6.0 | 1.23 | 30.0 | 36.0 |
| No. 02 | 40.0 | 8.0 | 1.23 | 40.0 | 48.0 |
| No. 03 | 5.0 | 9.0 | 10.11 | 5.0 | 14.0 |
| No. 04 | 2.0 | 3.0 | 8.57 | 2.0 | 5.0 |
| No. 05 | 40.0 | 15.0 | 2.29 | 40.0 | 55.0 |
| No. 06 | 40.0 | 10.0 | 1.54 | 40.0 | 50.0 |
| No. 07 | 30.0 | 15.0 | 3.03 | 30.0 | 45.0 |
| No. 08 | 30.0 | 10.0 | 2.04 | 30.0 | 40.0 |

TABLE 2

| No. 01 | | | | |
|---|---|---|---|---|
| Ignition | Maximum raise | | | |
| operation | in temperature (° C.) | | | |
| Point | TI-01 | TI-02 | TI-03 | Judgment |
| E-01 | 8.4 | 51.2 | 2.7 | N |
| E-02 | 0.9 | 3.1 | 2.1 | N |
| E-03 | 0.8 | 0.2 | 6.0 | N |

TABLE 3

| No. 02 | | | | |
|---|---|---|---|---|
| Ignition | Maximum raise | | | |
| operation | in temperature (° C.) | | | |
| Point | TI-01 | TI-02 | TI-03 | Judgment |
| E-01 | 7.1 | 2.3 | 2.1 | N |
| E-02 | 0.9 | 7.7 | 1.9 | N |
| E-03 | 0.9 | 0.0 | 4.9 | N |

TABLE 4

| No. 03 | | | | |
|---|---|---|---|---|
| Ignition | Maximum raise | | | |
| operation | in temperature (° C.) | | | |
| Point | TI-01 | TI-02 | TI-03 | Judgment |
| E-01 | 430.5 | 537.5 | 311.9 | Y+ |
| E-02 | 0.8 | 183.2 | 21.5 | Y+ |
| E-03 | 0.8 | 0.1 | 116.4 | Y− |

TABLE 5

| No. 04 | | | | |
|---|---|---|---|---|
| Ignition | Maximum raise | | | |
| operation | in temperature (° C.) | | | |
| Point | TI-01 | TI-02 | TI-03 | Judgment |
| E-01 | 544.9 | 338.0 | 150.8 | Y+ |
| E-02 | 0.9 | 236.1 | 24.3 | Y+ |
| E-03 | 0.9 | 0.0 | 111.5 | Y− |

TABLE 6

| No. 05 | | | | |
|---|---|---|---|---|
| Ignition | Maximum raise | | | |
| operation | in temperature (° C.) | | | |
| Point | TI-01 | TI-02 | TI-03 | Judgment |
| E-01 | 9.7 | 3.7 | 2.9 | N |
| E-02 | 0.9 | 7.8 | 1.8 | N |
| E-03 | 1.0 | 0.2 | 5.1 | N |

TABLE 7

| No. 06 | | | | |
|---|---|---|---|---|
| Ignition | Maximum raise | | | |
| operation | in temperature (° C.) | | | |
| Point | TI-01 | TI-02 | TI-03 | Judgment |
| E-01 | 7.6 | 2.7 | 2.4 | N |
| E-02 | 0.9 | 7.8 | 1.9 | N |
| E-03 | 0.9 | 0.1 | 5.2 | N |

TABLE 8

| No. 07 | | | | |
|---|---|---|---|---|
| Ignition | Maximum raise | | | |
| operation | in temperature (° C.) | | | |
| Point | TI-01 | TI-02 | TI-03 | Judgment |
| E-01 | 22.0 | 9.1 | 7.5 | N |
| E-02 | 0.9 | 9.3 | 2.0 | N |
| E-03 | 0.8 | 0.1 | 7.0 | N |

TABLE 9

| No. 08 | | | | |
|---|---|---|---|---|
| Ignition | Maximum raise | | | |
| operation | in temperature (° C.) | | | |
| Point | TI-01 | TI-02 | TI-03 | Judgment |
| E-01 | 12.3 | 4.8 | 3.8 | N |
| E-02 | 0.8 | 9.0 | 2.2 | N |
| E-03 | 0.8 | 0.0 | 6.7 | N |

As apparent from Table 1, the sum of the supply rate of the combustible gas and the supply rate of the combustion supporting gas was equal to the flow rate of the mixed gas at the outlet.

Also with reference to Table 1, the conditions Nos. 01, 02, 05 to 08, where the flow velocity of the combustible gas at the combustion supporting gas supply port was not less than 30 m/s, were examples of the present invention; whereas the conditions Nos. 03 and 04 were comparative examples. As understood from Tables 2 to 9, actual ignition (firing) was not observed in the examples of the present invention. Thus, it was confirmed that according to the present invention, a combustion reaction can be prevented effectively.

### Example 2

According to Embodiment 4, a combustible gas and a combustion supporting gas were mixed together under various conditions.

FIG. 16 schematically shows a cross-sectional view of a tubular mixing section of a mixing apparatus which was used. As the tubular mixing section 1′″, a straight tube made of SUS (stainless steel) and having an inner diameter of 20 mm and a length of 300 mm was used. As the combustion supporting gas supply tube 5′, a round tube made of SUS and having an inner diameter of 5 mm was used while its tip was connected to the tubular mixing section 1′″ in the form of a T-junction, and a center of an aperture of the combustion supporting gas supply port 5a was located at about 50 mm downstream from the one end 1a (the combustible gas supply port) of the tubular mixing section. Note that a porous membrane was not used in this example. The locations of the igniters E-01 to E-03 and the temperature sensors TI-01 to TI-03 were as described in Example 1. Gases used as the combustible gas and the combustion supporting gas were similar to those in Example 1. Thus, for the combustion velocity of the mixed gas of the combustible gas and the combustion supporting gas, about 30 m/s was noted as a guide, similarly to Example 1.

While the combustible gas and the combustion supporting gas were supplied at respective supply rates of conditions No. 11 to No. 21 shown in Table 10, for each of cases of conducting an ignition operation at E-01, conducting an ignition operation at E-02, and conducting an ignition operation at E-03, the maximum temperatures were measured at TI-01 to TI-03, and whether the operation brought about actual ignition (firing) at any of TI-01 to TI-03 or not was judged. Results are shown in Tables 11 to 21. Symbols in these tables are similar to those in Example 1.

TABLE 10

| | | | | Flow velocity of | |
|---|---|---|---|---|---|
| | | Supply rate of | Oxygen | Combustible gas | Flow velocity |
| | Supply rate of | Combustion | concentration | at Combustion | of mixed gas |
| | Combustible | supporting | at Outlet | supporting gas | at Outlet |
| Condition | gas (m/s) | gas (m/s) | (vol %) | supply port (m/s) | (m/s) |
| No. 11 | 30.0 | 6.0 | 1.23 | 30.0 | 36.0 |
| No. 12 | 40.0 | 8.0 | 1.23 | 40.0 | 48.0 |
| No. 13 | 5.0 | 1.0 | 1.23 | 5.0 | 6.0 |
| No. 14 | 10.0 | 9.0 | 5.33 | 10.0 | 19.0 |
| No. 15 | 5.0 | 9.0 | 10.11 | 5.0 | 14.0 |
| No. 16 | 5.0 | 3.0 | 3.61 | 5.0 | 8.0 |
| No. 17 | 2.0 | 3.0 | 8.57 | 2.0 | 5.0 |
| No. 18 | 40.0 | 15.0 | 2.29 | 40.0 | 55.0 |
| No. 19 | 40.0 | 10.0 | 1.54 | 40.0 | 50.0 |
| No. 20 | 30.0 | 15.0 | 3.03 | 30.0 | 45.0 |
| No. 21 | 30.0 | 10.0 | 2.04 | 30.0 | 40.0 |

TABLE 11

| No. 11 | | | | |
|---|---|---|---|---|
| Ignition | Maximum raise | | | |
| operation | in temperature (° C.) | | | |
| Point | TI-01 | TI-02 | TI-03 | Judgment |
| E-01 | 9.1 | 2.7 | 2.3 | N |
| E-02 | 1.0 | 3.3 | 4.0 | N |
| E-03 | 0.9 | 0.3 | 10.3 | N |

TABLE 12

| No. 12 | | | | |
|---|---|---|---|---|
| Ignition | Maximum raise | | | |
| operation | in temperature (° C.) | | | |
| Point | TI-01 | TI-02 | TI-03 | Judgment |
| E-01 | 9.1 | 2.7 | 2.3 | N |
| E-02 | 1.0 | 3.3 | 4.0 | N |
| E-03 | 0.9 | 0.3 | 10.3 | N |

TABLE 13

| No. 13 | | | | |
|---|---|---|---|---|
| Ignition | Maximum raise | | | |
| operation | in temperature (° C.) | | | |
| Point | TI-01 | TI-02 | TI-03 | Judgment |
| E-01 | 75.5 | 13.4 | 11.2 | Y− |
| E-02 | 1.0 | 92.5 | 23.1 | Y− |
| E-03 | 1.0 | 0.2 | 215.1 | Y+ |

TABLE 14

| No. 14 | | | | |
|---|---|---|---|---|
| Ignition | Maximum raise | | | |
| operation | in temperature (° C.) | | | |
| Point | TI-01 | TI-02 | TI-03 | Judgment |
| E-01 | 42.8 | 9.0 | 8.3 | Y− |
| E-02 | 1.7 | 49.2 | 14.9 | Y− |
| E-03 | 1.0 | 0.3 | 119.9 | Y− |

TABLE 15

| No. 15 | | | | |
|---|---|---|---|---|
| Ignition | Maximum raise | | | |
| operation | in temperature (° C.) | | | |
| Point | TI-01 | TI-02 | TI-03 | Judgment |
| E-01 | 343.9 | 301.2 | 257.9 | Y+ |
| E-02 | 239.9 | 455.9 | 406.2 | Y+ |
| E-03 | 140.2 | 243.6 | 485.5 | Y+ |

TABLE 16

| No. 16 | | | | |
|---|---|---|---|---|
| Ignition | Maximum raise | | | |
| operation | in temperature (° C.) | | | |
| Point | TI-01 | TI-02 | TI-03 | Judgment |
| E-01 | 125.8 | 16.7 | 15.1 | Y− |
| E-02 | 0.9 | 120.1 | 26.7 | Y− |
| E-03 | 1.0 | 0.3 | 268.5 | Y+ |

TABLE 17

| No. 17 | | | | |
|---|---|---|---|---|
| Ignition | Maximum raise | | | |
| operation | in temperature (° C.) | | | |
| Point | TI-01 | TI-02 | TI-03 | Judgment |
| E-01 | 391.6 | 238.4 | 170.0 | Y+ |
| E-02 | 201.7 | 417.4 | 271.4 | Y+ |
| E-03 | 88.2 | 152.2 | 415.6 | Y+ |

TABLE 18

| No. 18 | | | | |
|---|---|---|---|---|
| Ignition | Maximum raise | | | |
| operation | in temperature (° C.) | | | |
| Point | TI-01 | TI-02 | TI-03 | Judgment |
| E-01 | 8.7 | 2.6 | 2.2 | N |
| E-02 | 1.1 | 2.8 | 3.2 | N |
| E-03 | 1.0 | 0.3 | 8.2 | N |

TABLE 19

| No. 19 | | | | |
|---|---|---|---|---|
| Ignition | Maximum raise | | | |
| operation | in temperature (° C.) | | | |
| Point | TI-01 | TI-02 | TI-03 | Judgment |
| E-01 | 8.6 | 2.4 | 2.2 | N |
| E-02 | 1.1 | 2.8 | 3.6 | N |
| E-03 | 0.8 | 0.1 | 8.3 | N |

TABLE 20

| No. 20 | | | | |
|---|---|---|---|---|
| Ignition | Maximum raise | | | |
| operation | in temperature (° C.) | | | |
| Point | TI-01 | TI-02 | TI-03 | Judgment |
| E-01 | 10.6 | 3.1 | 2.6 | N |
| E-02 | 1.0 | 3.3 | 4.5 | N |
| E-03 | 1.0 | 0.1 | 10.1 | N |

TABLE 21

| No. 21 | | | | |
|---|---|---|---|---|
| Ignition | Maximum raise | | | |
| operation | in temperature (° C.) | | | |
| Point | TI-01 | TI-02 | TI-03 | Judgment |
| E-01 | 9.8 | 2.9 | 2.4 | N |
| E-02 | 0.9 | 3.1 | 4.5 | N |
| E-03 | 0.8 | 0.1 | 9.9 | N |

As apparent from Table 10, the sum of the supply rate of the combustible gas and the supply rate of the combustion supporting gas was equal to the flow rate of the mixed gas at the outlet.

Also with reference to Table 10, the conditions Nos. 11, 12, 18 to 21, where the flow velocity of the combustible gas at the combustion supporting gas supply port was not less than 30 m/s, were examples of the present invention; whereas the conditions Nos. 13 to 17 were comparative examples. As understood from Tables 11 to 21, actual ignition (firing) was not observed in the examples of the present invention. Thus, it was confirmed that according to the present invention, a combustion reaction can be prevented effectively.

### Example 3

According to Embodiment 7, a combustible gas and a combustion supporting gas were mixed together under various conditions.

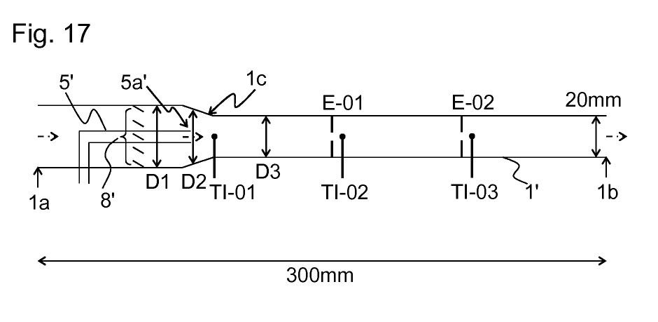

FIG. 17 schematically shows a cross-sectional view of a tubular mixing section of a mixing apparatus which was used. As the tubular mixing section 1′, a straight tube made of SUS (stainless steel) and having an inner diameter of about 20 mm and a length of 300 mm was used. A length of the tapered part 1a was 20 mm, an inner diameter D1 of the generally cylindrical part located at an upstream side of the tapered part 1c was 30 mm, and an inner diameter D3 of the generally cylindrical part located at a downstream side of the tapered part 1c was 21.2 mm. As the combustion supporting gas supply tube 5′, a round tube made of SUS and having an inner diameter of 5 mm was used while its tip was bent, and an aperture plane of the combustion supporting gas supply port 5a was located at about 50 mm downstream from the one end 1a (the combustible gas supply port) of the tubular mixing section to open towards the downstream. The combustion supporting gas supply port 5a′ was located within the tapered part 1c, and an inner diameter D2 of the tubular mixing section 1′ at this position was 23.4 mm. As the baffle 8′, eight fixed wings made of SUS as shown in FIG. 11 were used by attaching them to a periphery of the combustion supporting gas supply tube 5′ as shown in FIG. 17. A distance between each downstream end of the fixed wings and the combustion supporting gas supply port 5a was about 10 mm. In addition, igniters E-01 to E-02 and temperature sensors TI-01 to TI-03 were set at positions in the downstream-side vicinity of the combustion supporting gas supply port 5a′, between the combustion supplying gas supply port 5a′ and the other end 1b (the mixed gas outlet port), in the upstream-side vicinity of the other end 1b, as shown in the drawings. The igniter showed a temperature rise of about 10 to 20° C. by spark (measured in a flow at 15 m/s of a nitrogen gas only so as to involve no combustion reaction).

A gas used as the combustible gas was composed of 10% by volume of a mixed gas of 6 parts by weight of propylene and 4 parts by weight of hydrogen, and 90% by volume of a nitrogen gas. A gas used as the combustion supporting gas was 100% by volume of an oxygen gas. The combustion velocity of the mixed gas of the combustible gas and the combustion supporting gas was the combustion velocity of the mixed gas having the composition at the point H in FIG. 2; and as a guide, about 30 m/s was noted in view of a stability limit of flame for propane, which has a similar molecular structure to propylene used in this example.

While the combustible gas and the combustion supporting gas were supplied at respective supply rates of conditions No. 31 to No. 42 shown in Table 22, for each of cases of conducting an ignition operation at E-01, and conducting an ignition operation at E-02, the maximum temperatures were measured at TI-01 to TI-03, and whether the operation brought about actual ignition (firing) at any of TI-01 to TI-03 or not was judged. Results are shown in Tables 23 to 34. Symbols in these tables are similar to those in Example 1.

TABLE 22

| | | | | Flow velocity of | Flow |
|---|---|---|---|---|---|
| | | | | Swirl flow of | velocity |
| | | Supply rate of | Oxygen | Combustible gas | of mixed |
| | Supply rate of | Combustion | concentration | at Combustion | gas at |
| | Combustible | supporting | at Outlet | supporting gas | Outlet |
| Condition | gas (m/s) | gas (m/s) | (vol %) | supply port (m/s) | (m/s) |
| No. 31 | 15.0 | 3.0 | 1.23 | 15.0 | 18.0 |
| No. 32 | 30.0 | 6.0 | 1.23 | 30.0 | 36.0 |
| No. 33 | 40.0 | 8.0 | 1.23 | 40.0 | 48.0 |
| No. 34 | 5.0 | 1.0 | 1.23 | 5.0 | 6.0 |
| No. 35 | 10.0 | 9.0 | 5.33 | 10.0 | 19.0 |
| No. 36 | 5.0 | 9.0 | 10.11 | 5.0 | 14.0 |
| No. 37 | 5.0 | 3.0 | 3.61 | 5.0 | 8.0 |
| No. 38 | 2.0 | 3.0 | 8.57 | 2.0 | 5.0 |
| No. 39 | 40.0 | 15.0 | 2.29 | 40.0 | 55.0 |
| No. 40 | 40.0 | 10.0 | 1.54 | 40.0 | 50.0 |
| No. 41 | 30.0 | 15.0 | 3.03 | 30.0 | 45.0 |
| No. 42 | 30.0 | 10.0 | 2.04 | 30.0 | 40.0 |

TABLE 23

| No. 31 | | | | |
|---|---|---|---|---|
| Ignition | Maximum raise | | | |
| operation | in temperature (° C.) | | | |
| Point | TI-01 | TI-02 | TI-03 | Judgment |
| E-01 | 1.0 | 14.4 | 12.4 | N |
| E-02 | 1.0 | 0.2 | 42.7 | Y− |

TABLE 24

| No. 32 | | | | |
|---|---|---|---|---|
| Ignition | Maximum raise | | | |
| operation | in temperature (° C.) | | | |
| Point | TI-01 | TI-02 | TI-03 | Judgment |
| E-01 | 1.0 | 3.1 | 5.7 | N |
| E-02 | 0.8 | 0.2 | 10.1 | N |

TABLE 25

| No. 33 | | | | |
|---|---|---|---|---|
| Ignition | Maximum raise | | | |
| operation | in temperature (° C.) | | | |
| Point | TI-01 | TI-02 | TI-03 | Judgment |
| E-01 | 1.0 | 2.3 | 4.6 | N |
| E-02 | 0.9 | 0.4 | 7.7 | N |

TABLE 26

| No. 34 | | | | |
|---|---|---|---|---|
| Ignition | Maximum raise | | | |
| operation | in temperature (° C.) | | | |
| Point | TI-01 | TI-02 | TI-03 | Judgment |
| E-01 | 1.0 | 99.7 | 31.0 | Y− |
| E-02 | 0.9 | 0.3 | 188.4 | Y+ |

TABLE 27

| No. 35 | | | | |
|---|---|---|---|---|
| Ignition | Maximum raise | | | |
| operation | in temperature (° C.) | | | |
| Point | TI-01 | TI-02 | TI-03 | Judgment |
| E-01 | 0.9 | 70.4 | 48.3 | Y− |
| E-02 | 0.9 | 0.3 | 85.7 | Y− |

TABLE 28

| No. 36 | | | | |
|---|---|---|---|---|
| Ignition | Maximum raise | | | |
| operation | in temperature (° C.) | | | |
| Point | TI-01 | TI-02 | TI-03 | Judgment |
| E-01 | 183.8 | 607.3 | 650.8 | Y+ |
| E-02 | 92.4 | 219.1 | 499.0 | Y+ |

TABLE 29

| No. 37 | | | | |
|---|---|---|---|---|
| Ignition | Maximum raise | | | |
| operation | in temperature (° C.) | | | |
| Point | TI-01 | TI-02 | TI-03 | Judgment |
| E-01 | 0.9 | 129.6 | 52.8 | Y− |
| E-02 | 0.8 | 0.2 | 227.9 | Y+ |

TABLE 30

| No. 38 | | | | |
|---|---|---|---|---|
| Ignition | Maximum raise | | | |
| operation | in temperature (° C.) | | | |
| Point | TI-01 | TI-02 | TI-03 | Judgment |
| E-01 | 98.3 | 501.3 | 400.4 | Y+ |
| E-02 | 61.9 | 133.2 | 447.9 | Y+ |

TABLE 31

| No. 39 | | | | |
|---|---|---|---|---|
| Ignition | Maximum raise | | | |
| operation | in temperature (° C.) | | | |
| Point | TI-01 | TI-02 | TI-03 | Judgment |
| E-01 | 0.9 | 2.4 | 5.1 | N |
| E-02 | 0.9 | 0.1 | 7.9 | N |

TABLE 32

| No. 40 | | | | |
|---|---|---|---|---|
| Ignition | Maximum raise | | | |
| operation | in temperature (° C.) | | | |
| Point | TI-01 | TI-02 | TI-03 | Judgment |
| E-01 | 0.8 | 2.3 | 4.9 | N |
| E-02 | 0.9 | 0.0 | 7.7 | N |

TABLE 33

| No. 41 | | | | |
|---|---|---|---|---|
| Ignition | Maximum raise | | | |
| operation | in temperature (° C.) | | | |
| Point | TI-01 | TI-02 | TI-03 | Judgment |
| E-01 | 1.1 | 4.8 | 6.7 | N |
| E-02 | 0.9 | 0.1 | 11.3 | N |

TABLE 34

| No. 42 | | | | |
|---|---|---|---|---|
| Ignition | Maximum raise | | | |
| operation | in temperature (° C.) | | | |
| Point | TI-01 | TI-02 | TI-03 | Judgment |
| E-01 | 4.4 | 4.4 | 6.1 | N |
| E-02 | 0.2 | 0.2 | 10.2 | N |

As apparent from Table 22, the sum of the supply rate of the combustible gas and the supply rate of the combustion supporting gas was equal to the flow rate of the mixed gas at the outlet.

Also with reference to Table 22, the conditions Nos. 32, 33, 39 to 42, where the flow velocity of the swirl flow of the combustible gas at the combustion supporting gas supply port was not less than 30 m/s, were examples of the present invention; whereas the conditions Nos. 31, 34 to 38 were comparative examples. As understood from Tables 23 to 34, actual ignition (firing) was not observed in the examples of the present invention. Thus, it was confirmed that according to the present invention, the combustible gas and the combustion supporting gas can be mixed together while preventing a combustion reaction effectively, without filling the mixing section with packing.

### INDUSTRIAL APPLICABILITY

According to the present invention, there is provided a safer mixing apparatus which can effectively prevent propagation of occurrence of a combustion reaction although a combustible gas and a combustion supporting gas are mixed together.

The present application claims priority to Japanese Patent Application Nos. 2009-226837 and 2009-226841 both filed on Sep. 30, 2009, and both entitled “MIXING APPARATUS OF COMBUSTIBLE GAS AND COMBUSTION SUPPORTING GAS.” The contents of those applications are incorporated herein by the reference thereto in their entirety.

1. A mixing apparatus for mixing a combustible gas and a combustion supporting gas, which comprises:
a tubular mixing section for mixing the combustible gas and the combustion supporting gas;
a combustible gas supply port located at one end of the tubular mixing section;
a combustible gas transport device for supplying the combustible gas into the tubular mixing section from the combustible gas supply port;
a mixed gas outlet port of a mixed gas of the combustible gas and the combustion supporting gas located at the other end of the tubular mixing section; and
a combustion supporting gas supply tube connected to the tubular mixing section between the one end and the other end of the tubular mixing section for supplying the combustion supporting gas into the tubular mixing section from a combustion supporting gas supply port;
wherein the combustible gas transport device is able to control a flow velocity of the combustible gas at the combustion supporting gas supply port to be not less than a combustion velocity of the mixed gas of the combustible gas and the combustion supporting gas.

2. The mixing apparatus according to claim 1, wherein the tubular mixing section has at least one mixing member selected from the group consisting of a static mixer and a dispersive mixer between the combustion supporting gas supply port and the mixed gas outlet port.

3. The mixing apparatus according to claim 1, which further comprises a baffle located within the tubular mixing section between the one end of the tubular mixing section and the combustion supporting gas supply port, wherein the combustible gas transport device is able to control a flow velocity of a swirl flow of the combustible gas resulted by the baffle at the combustion supporting gas supply port to be not less than the combustion velocity of the mixed gas of the combustible gas and the combustion supporting gas.

4. The mixing apparatus according to claim 3, wherein the tubular mixing section has a tapered part between a position of the combustion supporting gas supply port and a position of the baffle so that a cross-sectional area of the tubular mixing section at the position of the combustion supporting gas supply port is smaller than a cross-sectional area of the tubular mixing section at the position of the baffle.

5. The mixing apparatus according to claim 3, wherein the combustion supporting gas supply tube is inserted into the tubular mixing section; a tip of the combustion supporting gas supply tube is bent coaxially with the tubular mixing section; and the baffle is attached to a periphery of the tip of the combustion supporting gas supply tube.

6. The mixing apparatus according to claim 1, wherein the combustion supporting gas supply tube is connected to a wall of the tubular mixing section at the combustion supporting gas supply port and includes a porous membrane at the combustion supporting gas supply port.

7. The mixing apparatus according to claim 1, wherein the combustible gas comprises hydrogen, and the combustion supporting gas comprises oxygen.

8. The mixing apparatus according to claim 7, wherein the combustible gas further comprises propylene.

9. The mixing apparatus according to claim 7, wherein the combustible gas further comprises an inert component.

10. A reaction apparatus comprising:
the mixing apparatus according to claim 1; and
a reactor connected to the mixed gas outlet port of the mixing apparatus.

11. The reaction apparatus according to claim 10, further comprising:
a control valve for controlling a flow rate of the combustion supporting gas flowing through the combustion supporting gas supply tube;
a measuring instrument for measuring a concentration of the combustion supporting gas in the reactor; and
a controller for controlling the flow rate of the combustion supporting gas flowing through the combustion supporting gas supply tube by the control valve based on the concentration of the combustion supporting gas in the reactor which is measured by the measuring instrument.

12. The reaction apparatus according to claim 11, wherein the controller is able to control the flow rate of the combustion supporting gas flowing through the combustion supporting gas supply tube by the control valve so as to maintain the concentration of the combustion supporting gas in the reactor at a substantially constant level.

13. The reaction apparatus according to claim 10, further comprising a recycle line for returning a gas in the reactor to the combustible gas transport device.

14. A process for producing a mixed gas, which comprises:
supplying a combustible gas into a tubular mixing section from one end of the tubular mixing section;
supplying a combustion supporting gas into the tubular mixing section from a combustion supporting gas supply port located between the one end and the other end of the tubular mixing section; and
discharging a mixed gas of the combustible gas and the combustion supporting gas from the other end of the tubular mixing section;
wherein the combustible gas supplied from the one end of the tubular mixing section is mixed with the combustion supporting gas supplied from the combustion supporting gas supply port and flows through the tubular mixing section to produce the mixed gas of the combustible gas and the combustion supporting gas from the other end of the tubular mixing section; and a supply flow rate of the combustible gas into the tubular mixing section is controlled so that a flow velocity of the combustible gas at the combustion supporting gas supply port is not less than a combustion velocity of the mixed gas of the combustible gas and the combustion supporting gas.

15. The process for producing the mixed gas according to claim 14, wherein the combustible gas supplied from the one end of the tubular mixing section is made into a swirl flow by a baffle, and then it is mixed with the combustion supporting gas supplied from the combustion supporting gas supply port; and the flow velocity of the combustible gas at the combustion supporting gas supply port is a flow velocity of the swirl flow.

16. The process for producing the mixed gas according to claim 15, wherein the combustible gas flows through the tubular mixing section in which a cross-sectional area of the tubular mixing section at a position of the combustion supporting gas supply port is smaller than a cross-sectional area of the tubular mixing section at a position of the baffle.

17. The process for producing the mixed gas according to claim 14, wherein the combustible gas comprises hydrogen, and the combustion supporting gas comprises oxygen.

18. The process for producing the mixed gas according to claim 17, wherein the combustible gas further comprises propylene.

19. The process for producing the mixed gas according to claim 17, wherein the combustible gas further comprises an inert component.

20. A process for supplying a mixed gas, which comprises:
supplying a reactor with the mixed gas produced by the process for producing the mixed gas according to claim 14;
measuring a concentration of the combustion supporting gas in the reactor; and
controlling the supply of the combustion supporting gas into the tubular mixing section.

21. The process for supplying the mixed gas according to claim 20, wherein the supply of the combustion supporting gas into the tubular mixing section is controlled so as to maintain the concentration of the combustion supporting gas in the reactor at a substantially constant level.

22. The process for supplying the mixed gas according to claim 20, which further comprises:
taking out a gas from the reactor to reuse the gas for the combustible gas which is to be supplied to the tubular mixing section.
